(19) United States
(12) Patent Application Publication
(10) Pub. No.: US 2009/0031394 A1
(43) Pub. Date: Jan. 29, 2009

(54) METHODS AND SYSTEMS FOR INTER-RESOURCE MANAGEMENT SERVICE TYPE DESCRIPTIONS

(75) Inventors: Alan Kavanagh, Montreal (CA); Frederic Rossi, Montreal (CA); Richard Tremblay, Rosemere (CA); Ludovic Beliveau, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/782,438

(22) Filed: Jul. 24, 2007

(51) Int. Cl. G06F 17/00

(52) U.S. Cl. 726/1

(57) ABSTRACT

Communication nodes, systems and methods are described which provide access screening for services based upon service type description information and policy criteria information associated with an access network. If a requested service is, e.g., banned due to regulatory policies in a geographic region associated with a particular access network, then the requested service shall be denied even if the user has a valid subscription to such requested service via another access network.

### TECHNICAL FIELD

The present invention generally relates to communication systems and methods and, more particularly, to mechanisms and techniques for providing service type descriptions in communication systems.

### BACKGROUND

In today's Internet Protocol (IP) based networks many applications require consistent network bandwidth and resources while an IP-based application is in use. For example, when an end User Device (UD) device starts to play a video being streamed from an Application Service Provider (ASP), the user watching the video may notice some packet loss causing the video stream to jitter or stall and buffer packets which interrupts the viewing. Though this may be acceptable for a Video-on-Demand (VoD) stream, where a suitable buffer and scheduler can prevent interruptions, but it will not typically be acceptable for Voice-over-IP (VoIP), IPTV or any hard real time services where the application requires the network to deliver the application or service to the end user device with minimum packet loss, delay, or jitter resulting in a guaranteed QoS.

Various standardization groups are working on reaching a consensus regarding the technology considerations which will affect “Next Generation Network” (NGN) design and implementation, including aspects associated with QoS issues in IP portions of the network. For example, Telecoms & Internet converged Services & Protocols for Advanced Networks (TISPAN) is an ETSI standardization group which focuses on convergence of technologies used in the Internet and other fixed networks. Among other things, TISPAN seeks to provide a modular, subsystem-oriented architecture which facilitates the addition of new subsystems over time to cover new demands and service classes. The TISPAN architecture attempts to ensure that network resources, applications, and user equipment are common to all of the various subsystems to provide for enhanced mobility across, for example, administrative boundaries.

One of the TISPAN subsystems is referred to as the Resource Admission Control Subsystem (RACS) and is intended to operate as a resource manager in such architectures, e.g., to handle, among other things, policy control, resource reservation and admission control within an IP based network to guarantee delivery of an application to the end-user when selected. Thus, RACS entities enable applications to request and reserve transport resources from the transport networks for which they are responsible. Currently, each RACS entity controls the resources within a single IP domain but does not span multiple IP domains and cannot control/reserve resources across multiple IP Domains. This leads to certain difficulties in terms of coordinating user subscriptions with local policy regulations and enforcement.

For example suppose that, with reference to FIG. 1, a subscriber and his or her end user device 10 are initially located in their home or local network, e.g., access network 20, which is located in Canada. At this time, the user operates the user device 10 to watch the movie “Batman Begins” from a local VoD ASP 30. The ASP 30 sends a request to the RACS 40, which is hosted in the access network, domain to request that access network resources be reserved before the video stream of “Batman Begins” is sent to the user device 10. Since “Batman Begins” is not restricted media in the context of the local access policies in Canada, the ASP 30 is able to provide this service to the user based on, for example, the service level agreement (SLA) with the access network domain. On the other hand, suppose that the same subscriber later travels to South Korea where she or he can obtain access to the network using the same or different user device 10 via a different access network 50. In this instance, suppose that the subscriber wants to watch a Canadian hockey match which is also sourced by the local VoD ASP 30. Hockey, however, is one of several banned sports programs in South Korea and should not be available for viewing via access network 50 notwithstanding that this particular subscriber may be able to gain access via his or her subscription to the VoD ASP 30. Today, there is no mechanism for enforcing these sorts of local policies regarding accessible program types in this type of network.

One mechanism for enforcing local access policies and restrictions is to require that both ASPs and access network domain providers permit access to only known services which they themselves have agreed upon will be provided by the ASPs. However, such a mechanism would be commercially unfeasible and consume significant resources associated with, for example, screening and negotiating agreements for every new service that an ASP offers. Thus, such a screening mechanism would greatly disrupt service rollout and offerings to users in many countries.

Accordingly, it would be desirable to have a mechanism for screening service and/or media stream access which avoids the afore-described problems and drawbacks.

### SUMMARY

According to an exemplary embodiment, a method for screening access to services in a communications network includes the steps of receiving a request for a service, comparing service type description information associated with the requested service to policy criteria information associated with an access network via which the service is requested to be supplied, and selectively requesting an allocation of resources for the requested service in the access network based on a result of the comparing step.

According to another exemplary embodiment, a communication node includes a processor for receiving a request for a service and comparing service type description information associated with the requested service to policy criteria information associated with an access network via which the service is requested to be supplied, wherein the processor selectively transmits a message requesting an allocation of resources for the requested service in said access network based on a result of the comparison.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a system in which issues associated with local policy enforcement may arise;

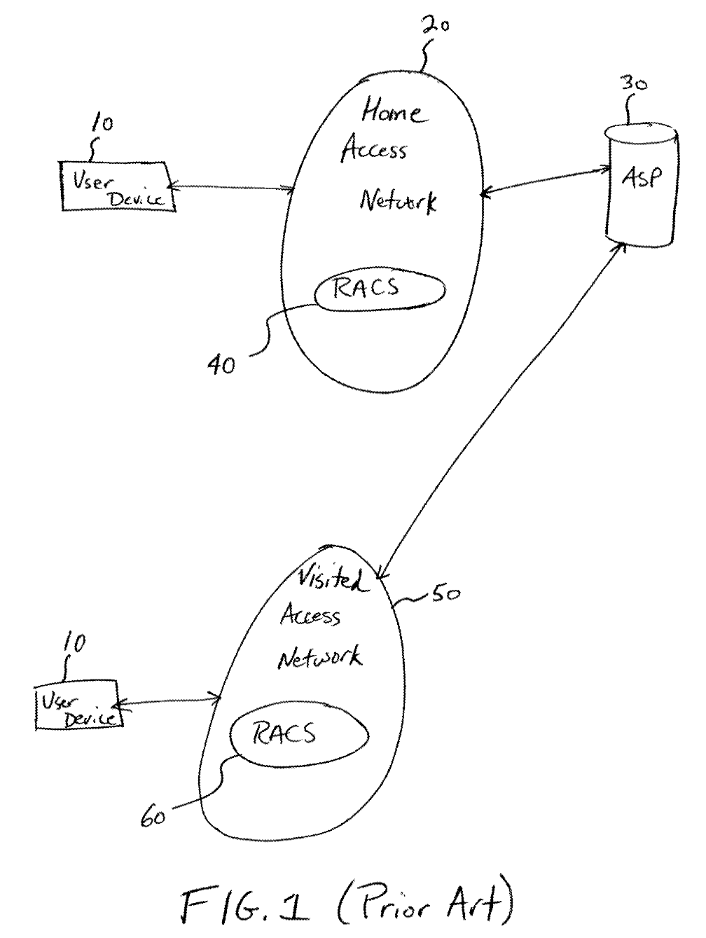

FIG. 2 illustrates a communication system according to an exemplary embodiment;

FIG. 3 illustrates an exemplary XML schema according to an exemplary embodiment;

FIG. 4 shows other aspects of the communication system of FIG. 2 according to an exemplary embodiment;

FIG. 5 is a flowchart illustrating a method for screening access to services in a communications network according to an exemplary embodiment; and

FIG. 6 is a communication node according to an exemplary embodiment.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

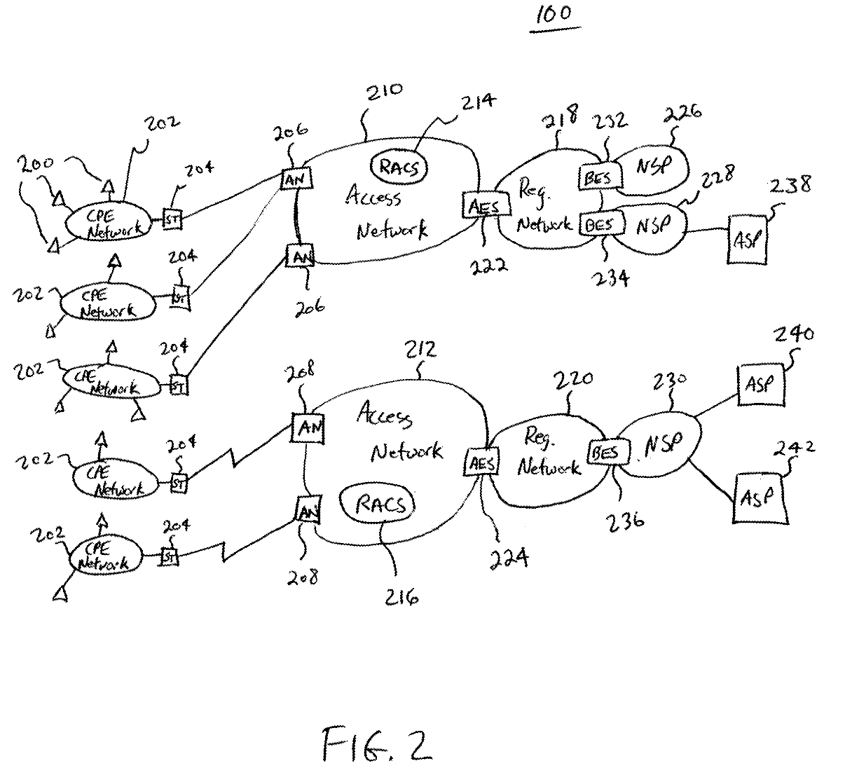

In order to provide some context within which exemplary embodiments will be better understood, consider the exemplary communication system 100 illustrated as FIG. 2 in which service type descriptions according these exemplary embodiments can be generated and/or used. It will be appreciated by those skilled in the art that this example is purely illustrative and that exemplary embodiments may be implemented in many types of networks other than the example provided as FIG. 2. Starting with the lefthand side of the Figure, a number of user devices (UDs) 200, e.g., computers, cellphones, IPTVs, PDAs and the like, receive and transmit data via consumer premises (CPE) networks 202, e.g., a local area network or a simple coaxial connection from a network termination point 204. The network termination point 204 can, for example, be a set-top box (ST) or residential gateway. The ST 204 can operate, for example, as a modem which receives and transmits data to the access nodes (ANs) 206, 208 via a “first/last” mile network.

In the exemplary system 100 of FIG. 2, two access networks 210 and 212 (e.g., Ethernet transport networks with ANs) are illustrated. The access network 210, and its associated ANs 206, can provide wireline access to some of the STs 204 as illustrated. The access network 212, and its associated ANs 208, can provide wireless access to some of the other STs 204. Each of the access networks 210 and 212 have their own RACS 214 and 216, respectively, associated therewith for handling resource management as described above. The access networks 210 and 212 are connected to respective regional networks (e.g., IP/MPLS transport networks) 218 and 220 via access edge sites 222 and 224, respectively. The regional networks 218 and 220 may also have their own RACS entities (not shown) and are connected in turn to one or more network service providers (NSPs) 226, 228 and 230 via border edge sites (BES) 232, 234 and 236, respectively. The NSPs can receive content, e.g., VoD programs, multicast IPTV programs, etc., for distribution to UDs 200 from, for example, application service providers (ASPs) 238, 240 and 242.

As mentioned above, there is currently no mechanism in place in systems, such as the system 100 described above, to enforce local access and policy restrictions regarding the type of service or media that is routed through a RACS-controlled local access network, such as access networks 210 and 212. Therefore, according to exemplary embodiments described below, when a service or media stream is being requested a mechanism is provided to define the type of service being requested and to determine if this service is permitted in the particular local access network that is providing connectivity to a UD 200 in accordance with, for example, government and local telecom policies. In addition to Boolean “authorized” or “not authorized” permissions, exemplary classification mechanisms according to these exemplary embodiments may also be used to permit the user to view selected services only at specific times. For example, using these exemplary embodiments, a parent could subscribes their children to enable viewing only of General Audience (GA) rated movies on their PC and to only permit gaming on weekends between the hours of 9.00 am and 1.00 pm.

More specifically, exemplary embodiments classify and categorize services or media using, e.g., an extensible Markup Language (XML) schema or other format which is appropriate for, e.g., inclusion in a Software Description Protocol (SDP) carried by SIP signaling (if an IMS architecture is used to implement system 100). The XML schema is, in turn, based upon a predetermined classification/categorization service definition, an example of which is provided below. Initially, the services/media can be classified into one (or more) of the following six service types:

VoIP

VoD

Streaming Broadcasting TV

Best Effort

Multimedia

Each of these service types may then be further categorized into sub-categories. For example the service type VoD can be further categorized into movies of the sub-type:

Horror

Action

Drama

Science Fiction

International

Adventure

Cartoon

Comedy

Adult Content

Documentary

Romance

Then these movies can be further classified using movie ratings such as, GA, PG13, PG, R or +18. Additional sub-types for movies may also be defined depending upon the parameters which are used in the various local access rules, e.g., the type of audio dialogue and visual effects used such as: violence and gore, sex and nudity, profanity, and/or substance use of drugs. The other service types may have analogous subclasses or types to match the criteria set forth in different local access regimes so that when the services and/or media are classified as described in these exemplary embodiments, the necessary information is available to provide local enforcement in accordance with local access rules. Thus it will be appreciated that the foregoing exemplary classification scheme is purely exemplary.

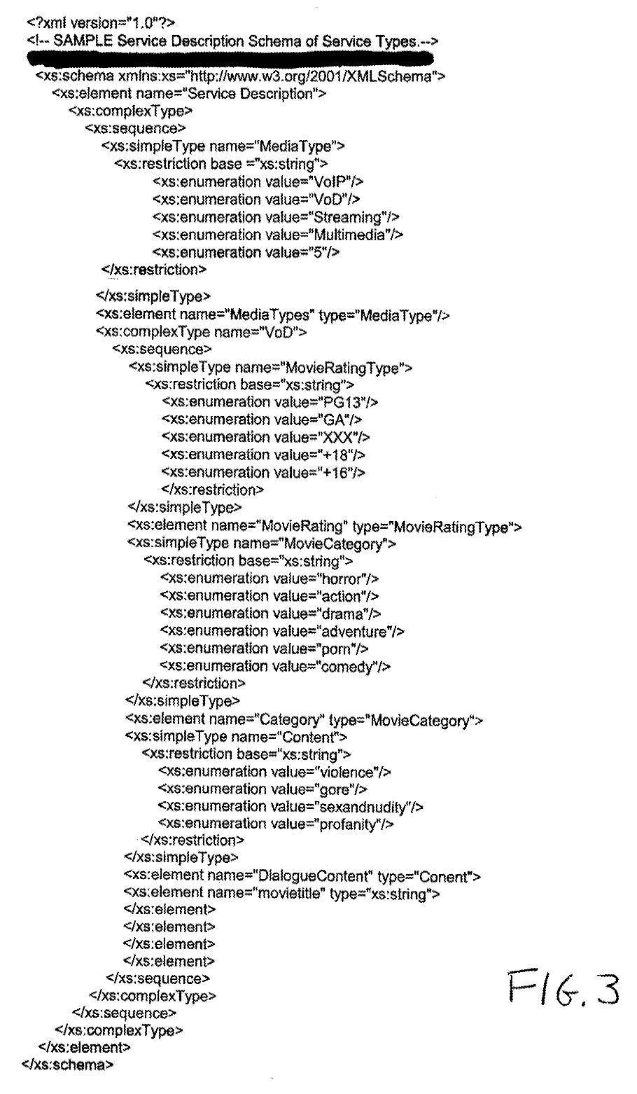

As mentioned above, once suitable classes, categories, subclasses and subcategories are selected for a particular implementation, the characterization of services and/or associated media can be performed by, for example, either an ASP or a third party service provider. This entity can type each service or associated media to be provided by the ASP using, e.g., a corresponding XML schema such as the exemplary XML schema depicted in FIG. 3. Therein, services and associated media are typed based on the above-described, exemplary classification scheme. Of course, this exemplary XML schema is a sample and further elements, e.g., complex and simple types, may be added to provide more granularity to the classification to more specifically describe the service as required depending on the local policies being enforced. Additionally, those skilled in the art will appreciate that the software mechanism which is used to type the services and/or associated media is not limited to being written in XML, other software languages could be employed for this purpose.

In implementation, the XML schema or comparable classification format developed in accordance with these exemplary embodiments can, for example, be deployed to facilitate screening of services and/or associated media in the system of FIG. 2, e.g., between two RACS systems 214, 216 or between a RACS system 214 and an application function (AF), e.g., NSP 226 or ASP 238. For example, the XML schema associated with a given ASP's library of service offerings may be resident on a server associated with NSP 226 or ASP 238 which server is part of the AF. This service type description information may be provided to, or accessed by, one of the communication nodes associated with system 100 in order to determine whether a particular request for service should be granted or denied based upon, for example, local policies associate with the access network which is currently providing service to the requesting user or other policies (e.g., parental controls) associated with that particular user's subscription. Thus screening according to exemplary embodiments involves a comparison between the service type description information associated with the requested service (e.g., stored or accessible as an XML schema via the AF) and the comparable information elements in the local governmental/regulatory access policies and/or parental control policies. As used herein, the phrase “policy criteria” is intended to generically refer to one or more of government, regulatory, parental or other access policies (either taken together or singly) against which the service type description information is compared.

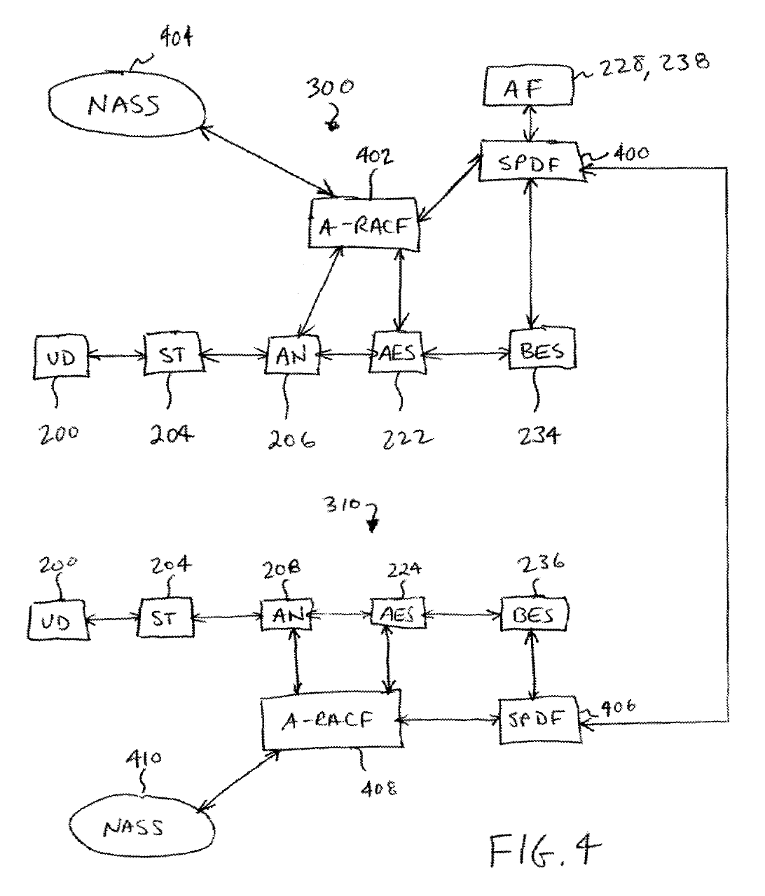

According to one exemplary embodiment, a Service Policy Decision Function (SPDF) node of the system can be the node which is responsible for using the service type description information provided by the AF to perform screening operations. Those skilled in the art will appreciate that, however, other communication nodes could alternatively be assigned this task. FIG. 4 illustrates the exemplary communication system of FIG. 2 wherein, among other things, the SPDF nodes are shown. Therein, as compared with the system of FIG. 2, more detail is provided with respect to the NASS sub-system elements and less detail is provided with respect to the physical system components, i.e., only two segments of the system 100 associated with a particular user in his or her home network 300 (upper portion of the Figure) and, subsequently, in a visited network 310 (lower portion of the Figure) are illustrated in FIG. 4. The physical system components are referenced using the same reference numerals used above with respect to FIG. 2 and the description of those elements is incorporated herein.

As illustrated, the SPDF 400 is disposed between the AF 228 and/or 238 and A-RACF 402, which is also connected to other NASS subsystems represented by element 404. The A-RACF entity 404 operates to, among other things, receive information about the IP address allocated to a particular user from other entities in the NASS 402 and map that IP allocation to physical resources in the access network 210. This information can then be provided to the access node 206 and access edge site 222 which are associated with this particular user's UD 200. The SPDF 400 operates as the RACS 214 point of contact which permits the AF 228, 238 to reserve transport resources from the access network 210 for provision of a requested service or associated media stream. The SPDF 400, in turn, contacts the A-RACF 402 which is monitoring the particular network segment associated with the user that requested the service or associated media stream. Similar comments apply to the SPDF 406, A-RACF 408 and NASS 410 in the visited network.

The SPDF 406 can communicate with the SPDF 400 in order to use the service type description information described above that is associated with the services and/or associated media which are provided by the AF 228, 238. There are many different ways in which the SPDFs 400, 406 can use this information according to exemplary embodiments in order to implement access screening according to policies associated with their respective access networks. For example, according to one exemplary embodiment, the SPDF 406 can store a priori identities of a subset of the services available from the AF 228, 238, specifically those services which are acceptable for access within the access network 212 based upon policy criteria information, e.g., information associated with governmental access policies associated with a geographical location in which the access network 212 provides connectivity. Then, requests for service can be compared with the stored service identities to determine whether the SPDF 406 shall request allocation of the resources needed to initiate the requested service, e.g., by contacting the A-RACF 408.

According to another exemplary embodiment, the SPDF 406 can request the service type description information associated with the specific service which has been requested by UD 200 (i.e., in response to the request) from SPDF 400. After SPDF 406 receives the service type description information from SPDF 400, it can then compare that service type description information with its policy criteria information to determine whether the requested service should be provided to the subscriber or not. These two exemplary embodiments are not intended to be exhaustive of the various implementations by way of which service type descriptions can be used to screen service accesses. Thus, e.g., using the earlier example from the Background section, suppose that the subscriber is now using the UD 200 in the visited network 310 and requests a hockey program which is available from AF 228, 238. In this example, the SPDF 406 will not request a resource allocation for this service request (and will initiate messaging refusing this request or may not even permit the UD 200 to initiate the request in the first instance by removing the selection from the available choices), since the hockey program service request will not match a permissible service request (or will match an impermissible service request) as described in the policy criteria information. Alternatively, the UD 200 in the visited network 310 could initiate a request for a service from AF 228, 238 which would communicate directly with the SPDF 406 via another portal (not shown) which request does not pass through the other SPDF 400. In this case the local SPDF 406 in the visited network 310 would deny the service request from the AF 228, 238, i.e., the UD 200 may select the movie via the portal or ST, but the SPDF 406 will deny the access based on its local access policies.

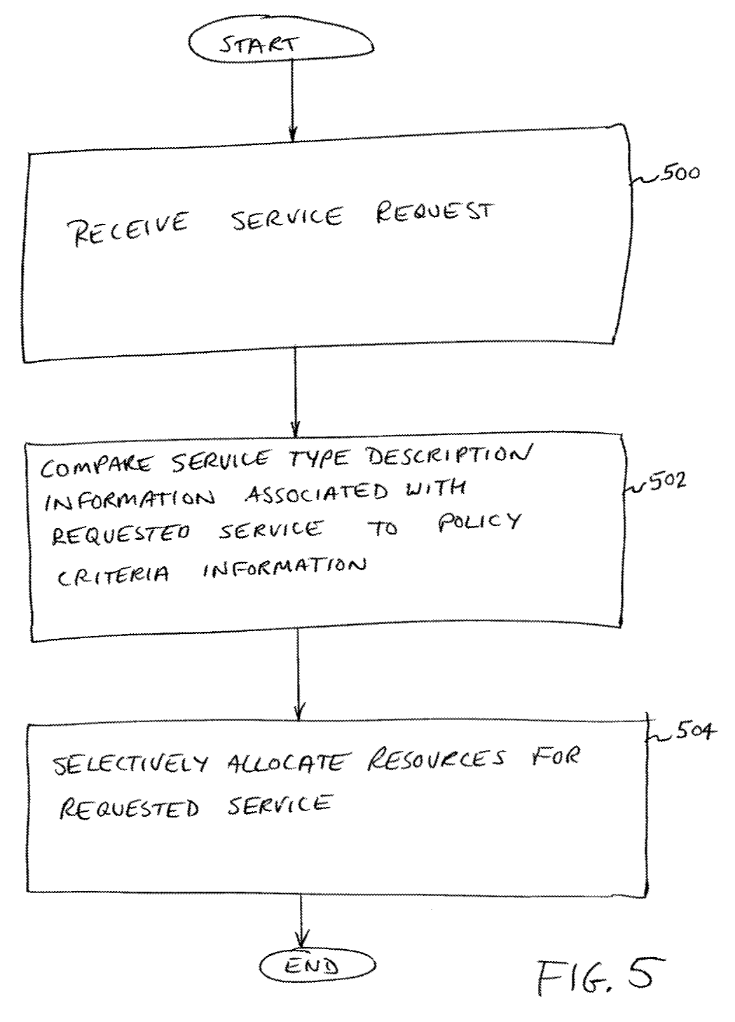

Thus it will be appreciated that these exemplary embodiments provide mechanisms for, e.g., allowing ASPs to offer services to access network domains globally without requiring the ASP, the access network domain and the regional network operators to screen each service before it is offered, regardless of the origin of the subscriber or the associated UD. A general method according to an exemplary embodiment is therefore illustrated as FIG. 5. Therein, at step 500, a request for a service is received. The service type description information associated with the requested service is compared with policy criteria information associated with the access network via which the service is requested to be supplied at step 502. Depending upon the result of the comparison, a request for allocation of resources for the requested service in the access network is issued at step 504.

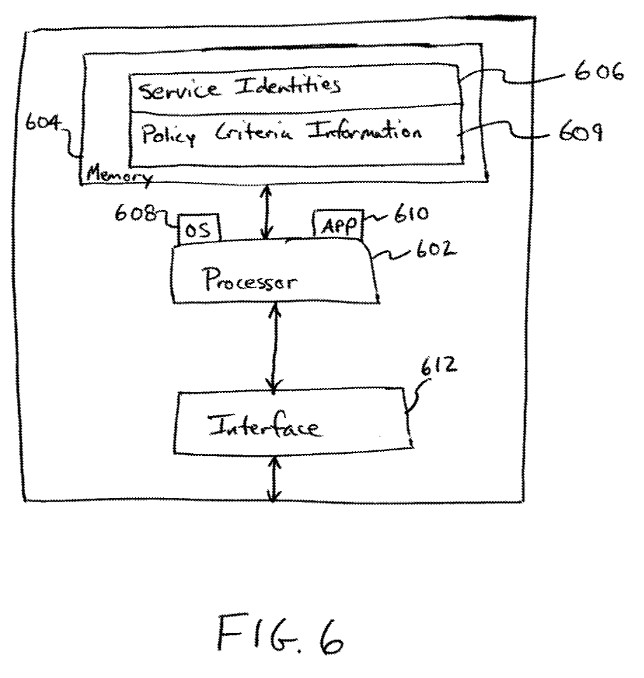

As described above, implementation of a service type description information or the like according to these exemplary embodiments can impact communication nodes in these types of systems. Structurally these nodes, e.g., SPDFs 400 and 406, can, for example, be implemented in hardware and software as servers or resident on servers which also serve other functions. For example, as shown generally in FIG. 6, such a server 600 can include a processor 602 (or multiple processor cores), memory device 604, an operating system 608 running on the processor 604 and using the memory 604, as well as a corresponding application 610, e.g., an SPDF application. The memory device 604 can, for example, store a subset of service identities 606 which are acceptable based upon policy criteria information 609 which may also be stored in memory device 604. An interface unit 612 may be provided to facilitate communications between the node 600 and the rest of the network or may be integrated into the processor 602. Thus, a communication node according to an exemplary embodiment may include a processor for receiving a request for a service and comparing service type description information associated with the requested service to policy criteria information associated with an access network via which the service is requested to be supplied, wherein the processor selectively transmits a message requesting an allocation of resources for the requested service in the access network based on a result of the comparison.

The foregoing description of exemplary embodiments provides illustration and description, but it is not intended to be exhaustive or to limit the invention to the precise form disclosed. Modifications and variations are possible in light of the above teachings or may be acquired from practice of the invention. The following claims and their equivalents define the scope of the invention.

1. A method for screening access to services in a communications network comprising:
receiving a request for a service;
comparing service type description information associated with said requested service to policy criteria information associated with an access network via which said service is requested to be supplied; and
selectively requesting an allocation of resources for said requested service in said access network based on a result of said comparing.

2. The method of claim 1, wherein said service type description information is stored on an application server.

3. The method of claim 1, wherein said policy criteria information is stored in a Service Policy Decision Function (SPDF) node associated with said access network.

4. The method of claim 1, wherein said comparing further comprises:
storing, by a communication node, identities of services available from at least one application service provider, which services are acceptable for access within said access network based upon said policy criteria information; and
comparing, in said communication node, said requested service with said identities to determine whether to request said allocation of said resources.

5. The method of claim 4, wherein said communication node is an SPDF node.

6. The method of claim 1, wherein said comparing further comprises:
requesting, by a communication node, said service type description information associated with said requested service from another communication node associated with an application function which would provide said requested service;
receiving said service type description information from said another communication node; and
comparing said service type description information with said policy criteria information.

7. The method of claim 1, wherein said communication node is an SPDF node associated with said access network and said another communication node is another SPDF node associated with a network to which said application function is connected.

8. The method of claim 1, wherein said service is an IPTV sports service associated with a hockey program, said policy criteria information indicates that hockey programs are banned and said allocation of resources is not requested.

9. The method of claim 1, wherein said policy criteria information includes governmental access policies associated with a geographical location in which said access network provides connectivity.

10. A communication node comprising:
a processor for receiving a request for a service and comparing service type description information associated with said requested service to policy criteria information associated with an access network via which said service is requested to be supplied, wherein
said processor selectively transmits a message requesting an allocation of resources for said requested service in said access network based on a result of said comparison.

11. The communication node of claim 10, further comprising:
a memory device wherein said policy criteria information is stored.

12. The communication node of claim 10, wherein said node is a Service Policy Decision Function (SPDF) node associated with said access network.

13. The communication node of claim 11, wherein said processor also stores identities of services available from at least one application service provider in said memory device, which services are acceptable for access within said access network based upon said policy criteria information, and wherein said processor compares said requested service with said identities to determine whether to request said allocation of said resources.

14. The communication node of claim 10, wherein said processor requests said service type description information associated with said requested service from another communication node associated with an application function which would provide said requested service, receives said service type description information from said another communication node, and compares said service type description information with said policy criteria information.

15. The communication node of claim 14, wherein said communication node is an SPDF node associated with said access network and said another communication node is another SPDF node associated with a network to which said application function is connected.

16. The communication node of claim 10, wherein said service is an IPTV sports service associated with a hockey program, said policy criteria information indicates that hockey programs are banned and said allocation of resources is not requested.

17. The communication node of claim 10, wherein said policy criteria information includes governmental access policies associated with a geographical location in which said access network provides connectivity.
